(19) United States
(12) Patent Application Publication
(10) Pub. No.: US 2022/0212327 A1
(43) Pub. Date: Jul. 7, 2022

(54) Hammer Drill Driving Bit Device

(71) Applicants: Eric Vilandre, New Bedford, MA (US); Paul Morelli, New Bedford, MA (US)

(72) Inventors: Eric Vilandre, New Bedford, MA (US); Paul Morelli, New Bedford, MA (US)

(21) Appl. No.: 17/143,285

(22) Filed: Jan. 7, 2021

(51) Int. Cl. B25D 17/00; B25D 17/08

(52) U.S. Cl. CPC B25D 17/005; B25B 31/00; B25D 17/08

(57) ABSTRACT

A hammer drill driving bit device for installing an anchor fastener includes a shaft. A first end of the shaft has a first recess extending axially thereinto. The first recess is arcuate and thus is complementary to a head of an anchor fastener, which can be inserted into the first recess. A second end of the shaft is engageable a chuck of a hammer drill so that the shaft is operationally engaged to the hammer drill. The shaft can engage the head of the anchor fastener, such that, with the anchor fastener positioned through a first hole in a first substrate, the hammer drill is positioned to drive the anchor fastener into a second hole in a second substrate. The anchor fastener expands to engage a wall of the second hole to couple the first substrate to the second substrate.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to driving bit devices and more particularly pertains to a new driving bit device for installing an anchor fastener. The present invention discloses a driving bit device comprising a shaft having a first end configured to engage a head of an anchor fastener and a second end adapted to be engageable to a chuck of a hammer drill

### (2) Description of Related Art Including Information Disclosed Under 37 CFR 1.97 and 1.98

The prior art relates to driving bit devices, which may comprise devices that engage both drill bits and anchor fasteners and which translate rotation of the drill bits into a percussive force upon the anchor fasteners. Prior art relates driving bit devices also may comprise sleeves, which are positionable around anchor fasteners for guiding percussive rams or are positionable over drill bits for adapting them to engage anchor fasteners. What is lacking in the prior art is a driving bit device comprising a shaft having a first end configured to engage a head of an anchor fastener and a second end adapted to be engageable to a chuck of a hammer drill.

### BRIEF SUMMARY OF THE INVENTION

An embodiment of the disclosure meets the needs presented above by generally comprising a shaft. A first end of the shaft has a first recess extending axially thereinto. The first recess is arcuate and thus is complementary to and configured for insertion of a head of an anchor fastener. A second end of the shaft is configured to engage a chuck of a hammer drill so that the shaft is operationally engaged to the hammer drill. The shaft is configured to engage the head of the anchor fastener, such that, with the anchor fastener positioned through a first hole in a first substrate, the hammer drill is positioned to drive the anchor fastener into a second hole in a second substrate. The anchor fastener expands to engage a wall of the second hole to couple the first substrate to the second substrate.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a hammer drill driving bit device according to an embodiment of the disclosure.

FIG. 2 is a first end view of an embodiment of the disclosure.

FIG. 3 is a second end view of an embodiment of the disclosure.

FIG. 4 is a side view of an embodiment of the disclosure.

FIG. 5 is a cross-sectional view of an embodiment of the disclosure.

FIG. 6 is a cross-sectional view of an embodiment of the disclosure.

FIG. 7 is an in-use view of an embodiment of the disclosure.

FIG. 8 is an in-use view of an embodiment of the disclosure.

### (j) DETAILED DESCRIPTION OF THE INVENTION

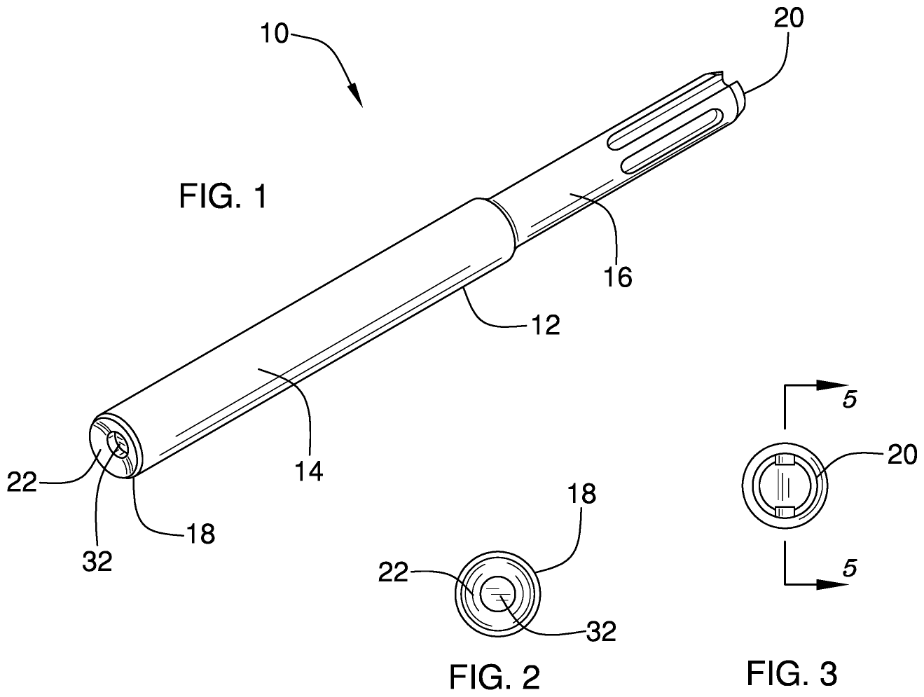

With reference now to the drawings, and in particular to FIGS. 1 through 8 thereof, a new driving bit device embodying the principles and concepts of an embodiment of the disclosure and generally designated by the reference numeral 10 will be described.

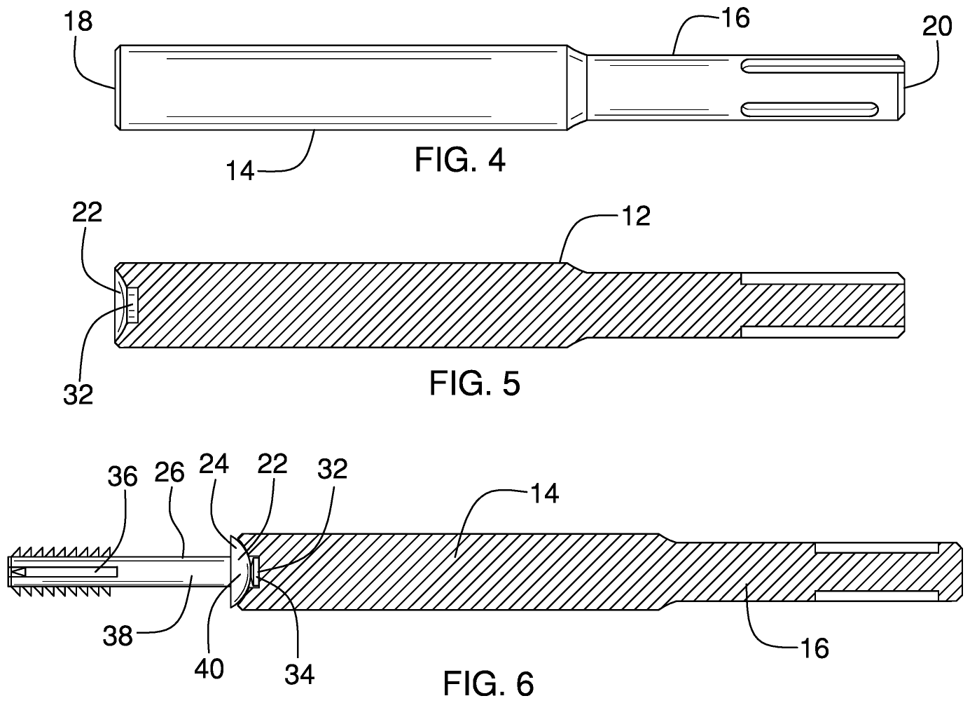

As best illustrated in FIGS. 1 through 8, the hammer drill driving bit device 10 generally comprises a shaft 12. The shaft 12 comprises a first section 14 and a second section 16, with the first section 14 extending from a first end 18 toward a second end 20 of the shaft 12. The second section 16 extends from the second end 20 to the first section 14. The first section 14 is circumferentially larger than the second section 16, as shown in FIG. 4. The first section 14 is tapered proximate to the second section 16, such that there is a smooth transition between the first section 14 and the second section 16. The shaft 12 comprises steel. The shaft 12 may comprise hardened steel.

The first end 18 of the shaft 12 has a first recess 22 extending axially thereinto. The first recess 22 is arcuate and thus is complementary to and configured for insertion of a head 24 of an anchor fastener 26, as shown in FIG. 6. The anchor fastener 26 may include a crimp anchor, a split drive anchor, a spike anchor, or the like.

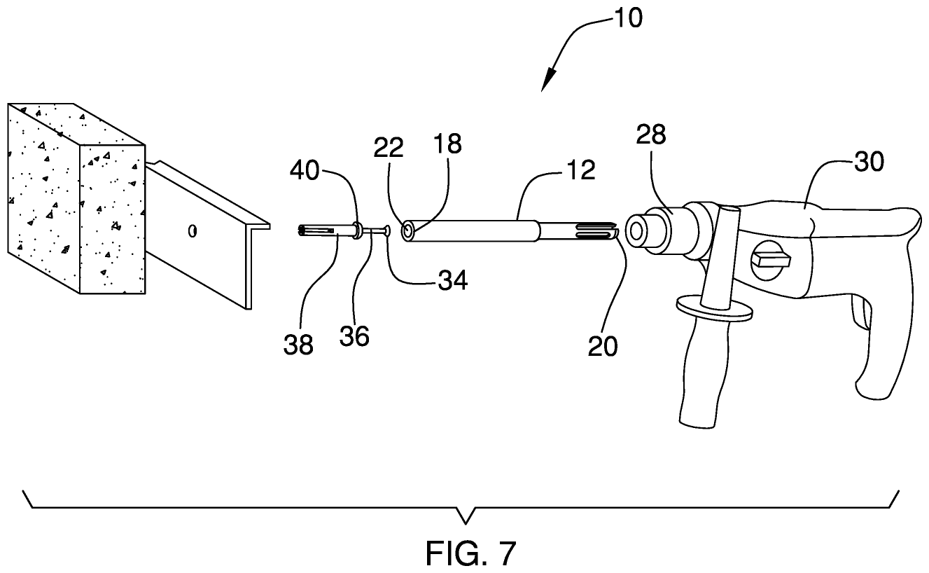

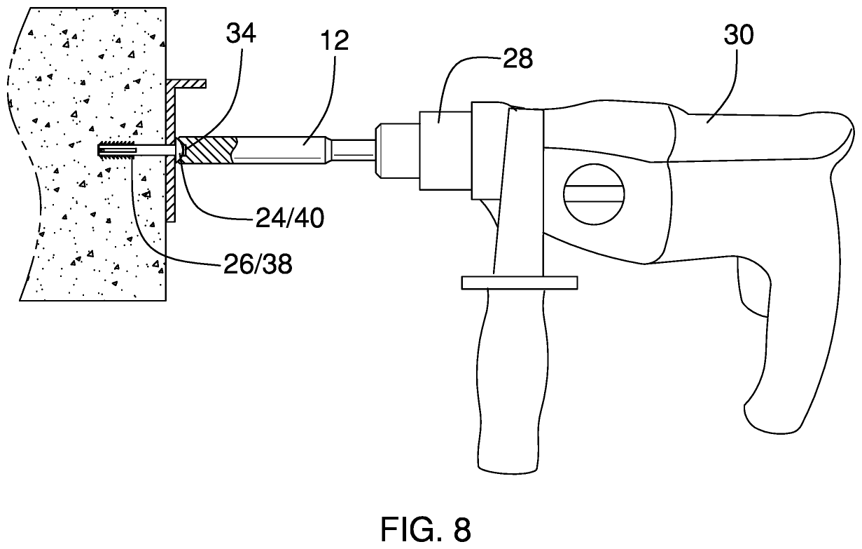

The second end 20 of the shaft 12 is configured to engage a chuck 28 of a hammer drill 30, as shown in FIGS. 7 and 8, so that the shaft 12 is operationally engaged to the hammer drill 30. The shaft 12 is configured to engage the head 24 of the anchor fastener 26, such that, with the anchor fastener 26 positioned through a first hole in a first substrate, the hammer drill 30 is positioned to drive the anchor fastener 26 into a second hole in a second substrate, such as concrete. The anchor fastener 26 expands to engage a wall of the second hole to couple the first substrate to the second substrate.

The first end 18 of the shaft 12 is beveled, as shown in FIG. 6. The first end 18 being beveled allows the anchor fastener 26 to be driven into the second hole to a point where the head 24 of the anchor fastener 26 engages the first substrate.

The first recess 22 has a second recess 32 extending therefrom axially into the shaft 12. The second recess 32 is disc shaped and thus is complementary to and configured for insertion of a head 34 of a pin 36 of the anchor fastener 26. The shaft 12 thus is configured to engage the head 34 of the pin 36. The second recess 32 may extend into the shaft 12 so that the second recess 32 is configured for insertion of approximately one half of the head 34 of the pin 36.

With a sleeve 38 of the anchor fastener 26 positioned through the first hole in the first substrate and extending into the second hole in the second substrate, the hammer drill 30 is positioned to drive the pin 36 into the sleeve 38 to expand the sleeve 38. The sleeve 38 engages the wall of the second hole to couple the first substrate to the second substrate. With the first recess 22 being arcuate, it also is complementary to and configured for insertion of a head 40 of the sleeve 38 as the pin 36 is driven into the sleeve 38. The anchor fastener 26 includes, but is not limited to, a drive pin rivet, a hammer drive anchor, or the like.

In use, the first substrate is abutted to the second substrate so that the first hole is aligned with the second hole. The sleeve 38 of the anchor fastener 26 is inserted through the first hole into the second hole. The head 34 of the pin 36 then is inserted into the second recess 32 and the hammer drill 30 is actuated to drive the pin 36 into the sleeve 38 to a point where the head 34 of the pin 36 meets the head 40 of the sleeve 38, the head 40 of the sleeve 38 engages the first substrate, and the head 40 of the sleeve 38 is positioned in the first recess 22. The first substrate thus is coupled to the second substrate.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hammer drill driving bit device comprising:
a shaft having a first end and a second end; and
the first end having a first recess extending axially thereinto, the first recess being arcuate such that the first recess is complementary to and configured for insertion of a head of an anchor fastener;
the second end being configured for engaging a chuck of a hammer drill such that the shaft is operationally engaged to the hammer drill, wherein the shaft is configured for engaging the head of the anchor fastener, such that, with the anchor fastener positioned through a first hole in a first substrate, the hammer drill is positioned for driving the anchor fastener into a second hole in a second substrate, such that the anchor fastener expands to engage a wall of the second hole for coupling the first substrate to the second substrate;
wherein the first recess is arcuate such that the first recess is complementary to and configured for insertion of a head of a sleeve of the anchor fastener; and
a second recess extending from the first recess axially into the shaft, the second recess being disc shaped, the second recess having a depth extending into the shaft less than a depth the first recess extends into the shaft such that the second recess is shallower than the first recess and complementary to and configured for insertion of a head of a pin of the anchor fastener into the second recess, the shaft being solid extending along a central longitudinal axis of the shaft from the second end of the shaft to the second recess wherein the shaft is configured for engaging the head of the pin, such that, with the sleeve positioned through the first hole in the first substrate and extending into the second hole in the second substrate, the hammer drill is positioned for driving the pin into the sleeve for expanding the sleeve such that the sleeve engages the wall of the second hole for coupling the first substrate to the second substrate.

2. The hammer drill driving bit device of claim 1, wherein the shaft comprises a first section and a second section, the first section extending from the first end toward the second end, the second section extending from the second end to the first section, the first section being circumferentially larger than the second section.

3. The hammer drill driving bit device of claim 2, wherein the first section is tapered proximate to the second section.

4. The hammer drill driving bit device of claim 1, wherein the first end is beveled.

5. The hammer drill driving bit device of claim 1, wherein the shaft comprises steel.

6. The hammer drill driving bit device of claim 5, wherein the shaft comprises hardened steel.

7. (canceled)

8. The hammer drill driving bit device of claim wherein the second recess extends into the shaft such that the second recess is configured for insertion of approximately one half of the head of the pin.

9. A hammer drill driving bit system comprising:
a hammer drill;
an anchor fastener;
a shaft having a first end and a second end, the first end having a first recess extending axially thereinto, the first recess being arcuate such that the first recess is complementary to and positioned for insertion of a head of the anchor fastener;
the second end being configured for engaging a chuck of the hammer drill such that the shaft is operationally engaged to the hammer drill, such that the shaft is positioned for engaging the head of the anchor fastener, such that, with the anchor fastener positioned through a first hole in a first substrate, the hammer drill is positioned for driving the anchor fastener into a second hole in a second substrate, such that the anchor fastener expands to engage a wall of the second hole for coupling the first substrate to the second substrate;
the anchor fastener comprises a sleeve and a pin;
the first recess is arcuate such that the first recess is complementary to and positioned for insertion of a head of the sleeve; and
a second recess extending from the first recess axially into the shaft, the second recess being disc shaped, the second recess having a depth extending into the shaft less than a depth the first recess extends into the shaft such that the second recess is shallower than the first recess and complementary to and configured for insertion of a head of a pin of the anchor fastener into the second recess, the shaft being solid extending along a central longitudinal axis of the shaft from the second end of the shaft to the second recess such that the shaft is positioned for engaging the head of the pin, such that, with the sleeve positioned through the first hole in the first substrate and extending into the second hole in the second substrate, the hammer drill is positioned for driving the pin into the sleeve for expanding the sleeve such that the sleeve engages the wall of the second hole for coupling the first substrate to the second substrate.

10. The hammer drill driving bit system of claim 9, wherein the shaft comprises a first section and a second section, the first section extending from the first end toward the second end, the second section extending from the second end to the first section, the first section being circumferentially larger than the second section.

11. The hammer drill driving bit device of system 10, wherein the first section is tapered proximate to the second section.

12. The hammer drill driving bit system of claim 9, wherein the first end is beveled.

13. The hammer drill driving bit system of claim 9, wherein the shaft comprises steel.

14. The hammer drill driving bit system of claim 13, wherein the shaft comprises hardened steel.

15. (canceled)

16. The hammer drill driving bit system of claim 9, wherein the second recess extends into the shaft such that the second recess is positioned for insertion of approximately one half of the head of the pin.

17. A hammer drill driving bit device comprising:
a shaft having a first end and a second end, the shaft comprising a first section and a second section, the first section extending from the first end toward the second end, the second section extending from the second end to the first section, the first section being circumferentially larger than the second section, the first section being tapered proximate to the second section, the first end being beveled, the shaft comprising hardened steel;
the first end having a first recess extending axially thereinto, the first recess being arcuate such that the first recess is complementary to and configured for insertion of a head of a sleeve of an anchor fastener;
a second recess extending from the first recess axially into the shaft, the second recess being disc shaped, the second recess having a depth extending into the shaft less than a depth the first recess extends into the shaft such that the second recess is shallower than the first recess and complementary to and configured for insertion of a head of a pin of the anchor fastener into the second recess; and
the second end being configured for engaging a chuck of a hammer drill such that the shaft is operationally engaged to the hammer drill, the shaft being solid extending along a central longitudinal axis of the shaft from the second end of the shaft to the second recess wherein the shaft is configured for engaging the head of the pin, such that, with the sleeve positioned through a first hole in a first substrate and extending into a second hole in a second substrate, the hammer drill is positioned for driving the pin into the sleeve for expanding the sleeve such that the sleeve engages a wall of the second hole for coupling the first substrate to the second substrate, the second recess extending into the shaft such that the second recess is configured for insertion of approximately one half of the head of the pin.
